(19) United States
(12) Patent Application Publication
(10) Pub. No.: US 2017/0284503 A1
(43) Pub. Date: Oct. 5, 2017

(54) ELEVATOR TENSION ELEMENT BELT WITH FLAME-RETARDANT PROPERTIES

(71) Applicants: INVENTIO AG; CONTITECH ANTRIEBSSYSTEME GMBH

(72) Inventors: Hubert Göser, Dannenberg (DE); Stephan Brocke, Hamburg (DE)

(21) Appl. No.: 15/507,278

(22) PCT Filed: Aug. 21, 2015
(86) PCT No.: PCT/EP2015/069285

§ 371 Date: Feb. 28, 2017

(30) Foreign Application Priority Data
Aug. 29, 2014 (DE) 102014217309.4

(51) Int. Cl. F16G 1/08; D07B 1/22; B05D 1/18; B05D 1/28; B66B 7/06; B05D 1/02

(52) U.S. Cl. CPC F16G 1/08; B66B 7/062; B05D 1/02; B05D 1/18; B05D 1/28; D07B 1/22; F16G 1/12

(57) ABSTRACT

A belt for drive systems includes: an elastic and flame-retardant belt body made from a polymeric material and at least one flame retardant additive, the belt body having a cover layer as a belt back and a substructure which has a force transmission zone; and a tension member embedded in the belt body, wherein the belt body is partially or completely provided with a coating, which coating is single- or multi-layered.

### FIELD

The invention pertains to a belt for drive systems that consists of at least:
a belt body of at least one polymeric material with elastic and flame-retardant properties, which comprises a cover layer in the form of a belt back and a substructure with a force transmission zone; and
a tension member embedded in the belt body.

### BACKGROUND

Such belts are also referred to as drive belts or power transmission belts and may be realized in the form of flat belts, V-belts, ribbed V-belts, synchronous belts or in the form of composite cables.

The elasticity of the belt is achieved in that the belt body and therefore the cover layer and the substructure consist of a polymeric material with elastic properties, particularly a polymeric material of the two material groups elastomers and thermoplastic elastomers. Elastomers on the basis of a vulcanized rubber compound containing at least one rubber component and compounding ingredients are particularly advantageous in this respect. The rubber component used consists, in particular, of ethylene-propylene rubber (EPM), ethylene-propylene-diene rubber (EPDM), (partially) hydrogenated nitrile rubber (HNBR), fluororubber (FKM), natural rubber (NR), chloroprene rubber (CR), styrene-butadiene rubber (SBR), butadiene rubber (BR) or polyurethane (PU), wherein these rubber components are either used in unblended form or blended with at least one other rubber component, particularly with one of the cited rubber types, for example in the form of an EPM/EPDM or SBR/BR blend. In this context, HNBR, EPM, EPDM, PU or an EPM/EPDM blend are particularly advantageous. The compounding ingredients comprise at least one vulcanizing agent or vulcanizing system (vulcanizing agent and accelerator). Other compounding ingredients usually are a filler and/or an auxiliary processing agent and/or a softener and/or an antiaging agent and, if applicable, additives such as reinforcing fibers and color pigments. In this respect, we refer to the general state of rubber compounding technology.

The belt is provided with an embedded tension member that is formed by at least one tension cord extending in the longitudinal belt direction. In most instances, several tension cords form a tension member layer. A tension member in the form of a cord construction is particularly advantageous, wherein the prior art includes different material concepts in this respect. The essential material types are: steel, polyamide (PA), aramide, polyester, glass fibers, carbon fibers, basalt, polyetheretherketone (PEEK), polyethylene terephthalate (PET), polybenzoxazole (PBO) or polyethylene-2,6-naphtalate (PEN). In addition, the tension cord is usually prepared with an adhesive system, for example with resorcin-formaldehyde-latex (RFL), such that permanent adhesion to the surrounding polymeric material is ensured.

In endless closed belts for the automotive industry, the material steel meanwhile plays only a minor role. In this case, tension cords consisting of PE, PET, glass and/or basalt are used.

In non-endless closed belts in the form of tension elements for elevator systems, however, the tension cord material steel, particularly in the form of steel cords, is especially advantageous due to its high tensile strength.

One problem with all types of belts can be seen in that the polymeric material of the belt body is highly flammable. In case of a fire, the entire belt body material would burn away and, if applicable, also damage the tension member. This problem is particularly relevant to a belt-like tension element for elevator systems, in which the steel tension member can be damaged. In any case, the function and therefore the safety of the elevator would no longer be ensured.

It is already known from WO 2011/141068 A1, WO 2014/072093 A1 or also from WO 201 0/01 91 50 A1 to provide the polymeric material of a belt body, which consists of two different materials, with flame-retardant additives. The belt structures disclosed, in particular, in WO 2011/141068 A1 and WO 2014/072093 A1 are relatively complex, require special effort in the manufacturing process and therefore are also relatively expensive.

### SUMMARY

In order to enhance this prior art, the invention aims to make available a belt, particularly a tension element for elevator systems, in which the belt body material is characterized by superior flame-retardant properties in comparison with the prior art and the complexity of the belt structure is at the same time not increased.

This objective is attained in that the belt body consists of at least one polymeric material with elastic and flame-retardant properties and the belt body is partially or completely provided with a coating that consists of one or more layers.

It was surprisingly determined that the flame-retardant properties are not negatively affected by a thusly structured belt and the belt can be cost-effectively manufactured in a simple processing step.

In contrast to WO 2011/141068 A1 and WO 2014/072093 A1, in particular, no multi-layered manufacturing process with rubber compounds containing different proportions of flame-retardant additives is required.

All so-called flame retardants familiar to a person skilled in the art may be considered as flame-retardant additives. They may be selected, e.g., from the group containing: melamine phosphate, melamine polyphosphate, melamine cyanurate, ammonium polyphosphate, halogenated organic compounds (e.g. polytetrafluoroethylene), organic phosphoric acid esters (e.g. polyphosphoric acid diesters), organic phosphonates, polyphosphonates, red phosphorus, metal hydroxides (calcium hydroxide, magnesium hydroxide, aluminum hydroxide), metal carbonates (e.g. calcium carbonate, magnesium carbonate), glass powder and/or quartz powder.

In this case, a single substance class, for example melamine phosphate, or a two-component or multi-component system, for example a compound of melamine phosphate and melamine cyanurate, may be used.

The additives essentially are uniformly admixed to the polymer matrix of the base body in conventional amounts.

The total amount of flame-retardant additives preferably lies between 10 and 30 wt. %, particularly between 20 and 30 wt. %, especially between 25 and 30 wt. %.

The belt body may be partially or completely provided with a coating. This coating may consist of one or more layers.

Since the flame-retardant additives negatively affect the mechanical properties of the belt material, the belt has to be protected, in particular, at the most stressed locations. In this context, the substructure with its force transmission zone, which is in contact with the traction pulley, is subjected to the highest mechanical stresses. If the belt body is only partially provided with a coating, it is therefore preferred to provide the substructure with the coating.

All materials familiar to a person skilled in the art may be used as material for the coating. The utilization of a coating based on at least one polyurethane proved particularly advantageous. In this context, it is particularly preferred that the polyurethane of the coating is identical or at least very similar to the polyurethane, on which the belt body is preferably based. In this way, particularly sound adhesion and compatibility of the coating are achieved. The Shore hardness of the polyurethane of the coating and/or of the belt body is preferably greater than 80 ShA, particularly greater than 88 ShA. For example, suitable polyurethanes for the coating and/or for the belt body are ether-PU or ester-PU.

On the traction side, the polyurethane preferably has a very good abrasion resistance and a sufficiently high (μ>0.2) coefficient of friction. If the belt is also guided over back deflections, it may be advantageous if the coating has a lower coefficient of friction (μ<0.2).

The layer thickness of the coating preferably lies between 0.01 mm and 0.5 mm, particularly between 0.1 mm and 0.25 mm.

The coating is preferably applied onto the belt during the manufacturing process by means of spraying, brushing, rolling or by means of an immersion method.

In a preferred embodiment, the belt with flame-retardant and elastic properties is initially produced and the belt is then coated in at least one subsequent step. The coating material used consists of a polyurethane, which also serves as material for the belt body and was previously dissolved in at least one solvent in order to allow its spraying or brushing. The solvent is removed by means of a subsequent drying process and the polyurethane remains on the belt in the form of a coating. If applicable, this process can be repeated several times in order to increase the layer thickness.

The belt body may be additionally provided with at least one embedded layer. This layer particularly consists of a textile material in the form of a woven fabric or knitted fabric. This layer may also be realized flame-retardant, for example, in that the textile threads are prepared in a flame-retardant fashion.

The inventive belt is particularly used as a tension element in elevator systems, particularly in the form of composite cables, a flat belt or synchronous belt. In case of a fire, the fire is not distributed over the height of the entire elevator shaft by the tension element. A thusly constructed tension element catches fire very poorly and exhibits no deficiencies with respect to its mechanical properties. The elevator remains conditionally functional. Another advantage can be seen in that such a tension element cannot spread a building fire from one level to the next level.

### DESCRIPTION OF THE DRAWINGS

An exemplary embodiment of the invention is described below with reference to a schematic drawing, but the invention is by no means limited to this exemplary embodiment. In this drawing:

FIG. 1 shows a belt in the form of a flat belt with a belt core and a belt cover, which serves as a tension element for elevator systems, in cooperation with an unprofiled traction pulley.

### DETAILED DESCRIPTION

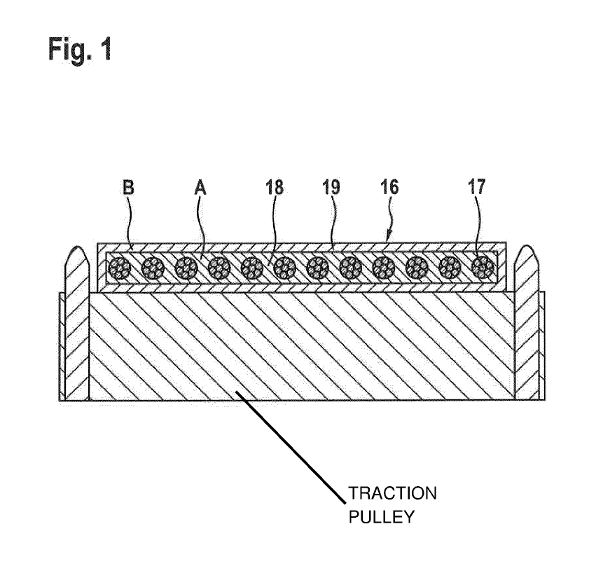

FIG. 1 shows a belt 16 in the form of a flat belt that serves as a tension element for elevator systems. The material A is preferably a polyurethane and forms the belt body or core 18. The cover or coating 19 consists of a material B, preferably a PU varnish that can be subjected to high mechanical stresses. In this case, the tension member 17 is completely encased in the first material A and thereby embedded in the belt core 18. The tension member 17 preferably consists of a tension member of steel. In this particularly preferred embodiment, the coating 19 completely surrounds the belt core 18.

In accordance with the provisions of the patent statutes, the present invention has been described in what is considered to represent its preferred embodiment. However, it should be noted that the invention can be practiced otherwise than as specifically illustrated and described without departing from its spirit or scope.

1-5. (canceled)

6. A belt for drive systems, comprising:
an elastic and flame-retardant belt core formed of a polymeric material and at least one flame-retardant additive;
a coating of at least one layer at least partially covering the belt core; and
at least one tension member embedded in the belt core.

7. The belt according to claim 6 wherein the at least one flame-retardant additive is melamine phosphate, melamine polyphosphate, melamine cyanurate, ammonium polyphosphate, a halogenated organic compound, an organic phosphoric acid ester, an organic phosphonate, red phosphorus, a metal hydroxide, a metal carbonate, glass powder or quartz powder.

8. The belt according to claim 6 wherein the belt in the form of one of a flat belt, a V-belt, a ribbed V-belt, a synchronous belt and composite cables.

9. The belt according to claim 6 formed as a tension element in an elevator drive system.

10. A method for manufacturing a belt according to claim 6 including a step of partially or completely applying the coating to the belt core by one of spraying, brushing, rolling and immersion after the belt core with the at least one tension member embedded is formed.

11. A belt for drive systems, comprising:
an elastic and flame-retardant belt core formed of a polymeric material and at least one flame-retardant additive;
a coating of at least one layer covering the belt core; and
a plurality of tension members embedded in the belt core.
